(19) United States
(12) Patent Application Publication
(10) Pub. No.: US 2024/0343594 A1
(43) Pub. Date: Oct. 17, 2024

(54) PROCESS FOR PRODUCING AMMONIUM BROMIDE

(71) Applicant: OBSHCHESTVO S OGRANICHENNOI OTVETSTVENNOSTIU "IRKUSTKAIA NEFTIANAIA KOMPANIA", Irkutsk (RU)

(72) Inventors: Viktor Aleksandrovich BEZBORODOV, Irkutsk (RU); Aleksei Olegovich PIVOVARCHUK, Irkutsk (RU); Evgenii Olegovich CHERTOVSKIKH, selo Nepa (RU)

(21) Appl. No.: 18/701,044

(22) PCT Filed: Nov. 16, 2021
(86) PCT No.: PCT/RU2021/000459

§ 371 Date: Apr. 12, 2024

(30) Foreign Application Priority Data
Oct. 18, 2021 (RU) 2021130176

(51) Int. Cl. C01C 1/16; C02F 1/58; C02F 101/12

(52) U.S. Cl. CPC C01C 1/166; C02F 1/58; C02F 2101/12

(57) ABSTRACT

The invention relates to chemical technology pertaining to mineral salts and can be used in the chemical industry. A process for producing ammonium bromide from a bromide-containing polycomponent hydromineral feedstock includes: two-stage oxidation of bromide ions using gaseous chlorine during acidification of a brine; air desorption of elementary bromide; absorption of same using a cooled solution of ammonium bromide; and reduction using an ammonia solution. The resulting concentrate of ammonium bromide is evaporated until crystals are formed. The ammonium bromide crystals are dried and the mother liquor is used to produce a solution of ammonium bromide as a commercial product.

The invention relates to technology for producing inorganic compounds, namely, to the process of producing ammonium bromide, which is used in pharmacology as a flame retardant and is also a convenient and cheap to transport feedstock for producing liquid bromine. The invention relates to chemical technology pertaining to mineral salts and can be used in the chemical industry.

### BACKGROUND

There is a known method for producing metal bromides [1] by reacting oxides, hydrates of oxides and carbonates of the respective metals with bromine in the presence of reducing agents and water, in which substances that produce only water, or gases, or water and gases together upon oxidation are used as reducing agents, for example, ammonia, urea, cyanamide, ammonium salts, ammonium carbonate, ammonium halides, formaldehyde, hydrazine, formic acid, formamide, oxalic acid, hydroxylamine, and mixtures thereof. According to this method, bromine and a solution of metal hydroxide or carbonate are dosed into an aqueous solution of a reducing agent. Reagents are dosed simultaneously, in portions, or one at a time. The resulting concentrated solution of bromide salt is filtered and evaporated; the finished product is isolated in a known manner. This method is low-productive and energy-intensive and does not provide a high-quality finished product.

There is a known method for producing ammonium bromide [2] by reacting a concentrated solution of ammonia with bromine. For the implementation of this method, the reactor is first cooled, then the bromine is added in small portions. The ammonia released from the solution and the resulting ammonium bromide smoke are captured with water or a weak solution of ammonium bromide.

The resulting solution is evaporated and then cooled, and the precipitated bromide crystals are removed, dried, and packaged.

There is a known method for producing bromides of alkali metals, calcium, and ammonium [3] by countercurrent extraction of bromide from a solution of iron (III) bromide with solutions of amine salts in an organic solvent, and re-extraction is performed with solutions of the respective metals in a countercurrent mode. In this case, along with bromides, a solution of iron (III) chloride is obtained.

The document [4] describes a method for producing bromine and its salts, which relates to the technique of absorbing halogens from gas mixtures with liquid absorbers. This invention aims to lower the losses of the reducing agent and alkaline agent, but there is no description of the process for producing the bromine-air mixture and of the feedstock used.

The closest is the method for producing bromide salts [5], in which bromine is absorbed with an excess amount of urea in an alkaline solution in an amount of 101%-101.5% of the theoretical one, followed by heating the solution to 60-65° C. with a calculated amount of bromine water. This method is energy-intensive and does not allow obtaining a high-quality finished product due to the formation of carbonates during the reduction of bromine.

### ESSENCE OF THE INVENTION

The purpose of the invention is to obtain high-quality crystalline ammonium bromide and its aqueous solution. The technical result consists in eliminating the stage of purifying the bromine-air mixture from chlorine, and maintaining high levels of purity of the final products and a high degree of bromine extraction.

The technical result is achieved through a two-stage process of oxidation of bromide ions to elementary bromine with gaseous chlorine, which allows minimizing the content of chlorine impurities in the bromine-air mixture without its additional purification.

In the process of absorbing bromine from the bromine-air mixture, a cooled, highly concentrated solution of ammonium bromide is used, which increases the degree of bromine absorption to 99%. The use of relatively cheap ammonia or ammonia water as a bromine reducer provides high economic performance in industrial production.

According to the claimed method for producing ammonium bromide from a bromide-containing polycomponent hydromineral feedstock of commercial brines of the chloride calcium-magnesium type, the brine stream, purified from dissolved iron, manganese, and insoluble impurities, is subjected to preheating to 30-35° C., neutralization of alkalinity, and acidification to pH values of 2.5 using mineral acids to prevent hydrolysis of free bromine, then the oxidation of bromide ions with gaseous chlorine to elementary bromine is performed in two stages: in Stage I, the oxidation of bromide ions to elementary bromine is performed at 73%-74% of the initial content in a flow chlorinator operating in a countercurrent mode; the air desorption of elementary bromine is performed in a countercurrent mode in a desorber; the absorption of elementary bromine from a bromine-air mixture is performed in a column-type mass transfer apparatus with a multidirectional screw nozzle operating in a countercurrent mode; a cooled ammonium bromide solution with a concentration of 400 g/dm³ is used as an absorbent; then the reduction of absorbed elementary bromine in the form of complex bromide (NH4 [Br2] Br) to bromide ions is performed in the reactor; the resulting ammonium bromide solution is purified from bromine impurities using formic acid, then the purified ammonium bromide solution is evaporated in two stages: in Stage I, evaporation is performed to a concentration of ammonium bromide of 50% in vacuum evaporators with water vapor recompression; in Stage II, evaporation is performed in evaporators equipped with steam jackets and anchor-type mixers, and evaporation is performed until a pulp containing ammonium bromide crystals is obtained, with a ratio of ammonium bromide to water of 3:1, the resulting pulp is cooled to 60-62° C. and subjected to centrifugation to separate crystalline ammonium bromide from the mother liquor, then the separated crystals are dried in a screw dryer, and after Stage I of desorption, a bromide-containing polycomponent hydromineral feedstock is supplied for the oxidation of bromide ions to elementary bromine with gaseous chlorine up to 88%-90% of its residual content in order to extract the residual amount of bromine.

In a preferred embodiment, the subsequent operations of air desorption of bromine, absorption of bromine-air mixture, reduction of absorbed elementary bromine, and purification of the resulting ammonium bromide solution are similar to Stage I of oxidation.

In another preferred embodiment, the purified ammonium bromide solution mixed with the mother liquor from the stage of obtaining crystalline ammonium bromide is evaporated to the required density to obtain the ammonium bromide solution as a commercial product.

The chlorinator is a vertical apparatus. The desorber is a column-type mass transfer apparatus. The reactor is a horizontal container divided by partitions into sections: in the first section, bromine is reduced to bromide ions with ammonia water with a concentration of 25% ammonia; in the second section of the reactor, the absorbent is degassed, and the released nitrogen is discharged into the atmosphere.

### LIST OF FIGURES

FIG. 1 schematically shows the sequence of actions of the method for producing ammonium bromide from a bromide-containing polycomponent hydromineral feedstock. The method includes acidification of the initial brine using 31.5% hydrochloric acid to prevent hydrolysis of free bromine to pH=2.5, then the acidified brine enters Stage I of oxidation with gaseous chlorine to 73%-74% of bromide ions from their initial content to elementary bromine with control of the oxidation process by the redox potential of the platinum electrode, then the oxidized water enters Stage I of desorption of elementary bromine by atmospheric air, which circulates in the system (bromine desorption is 95%). The bromine-air mixture (BAM) is directed for the absorption of bromine by a solution of ammonium bromide (absorbent). The absorbent saturated with bromine is periodically pumped into the reactor, where the process of reducing bromine to ammonium bromide (Stage I) occurs by dosing a 25% ammonia solution. The resulting ammonium bromide solution is used to produce crystalline ammonium bromide. The air after bromine extraction, containing some residual bromine, is used for desorption in Stage II. Waste water from Stage I of desorption enters Stage II of oxidation with gaseous chlorine, at which 88%-90% of bromide ions are oxidized from their residual content to elementary bromine. Next, water from Stage II of oxidation enters Stage II of air desorption of elementary bromine. Similar to Stage I, the bromine-air mixture is supplied for absorption by the same absorbent (solution of ammonium bromide). The absorbent saturated with bromine is periodically pumped into the reactor, where the process of reducing bromine to ammonium bromide (Stage II) occurs by dosing a 25% ammonia solution. The resulting ammonium bromide solution is used to produce the commercial form of ammonium bromide solution.

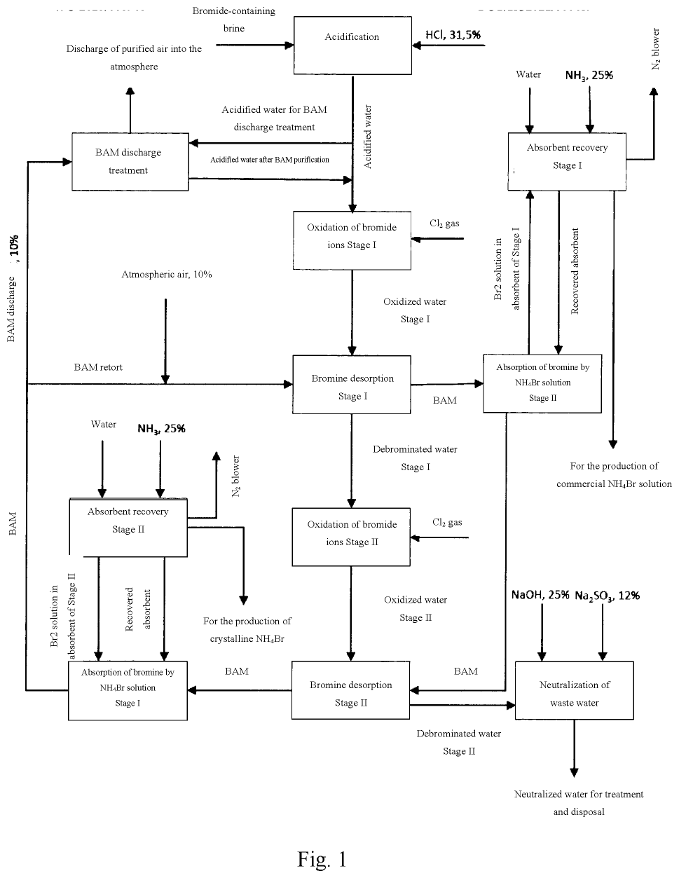

Waste water is sent for neutralization to prepare it for further disposal.

### IMPLEMENTATION OF THE INVENTION

Example 1. 2.43 m³ of brine with a density of ISO kg/m³, with a hydrogen index of 5.7 of the following composition: (Ca2+, Mg2+, Sr2+)=31.7 kg/m³; Feₜₒₜₐₗ=0.002 kg/m³; Mg2+=0.003 kg/m³; (K+, Na+, Li+)=27.42 kg/m³; Cl=74.37 kg/m³; HCO3−=0.03 kg/m³; SO42−=0.73 kg/m³; Br=2.40 kg/m³ was acidified with 31.5% hydrochloric acid to pH=2.5 and subjected to Stage I of oxidation with gaseous (anodic) chlorine to a residual content of Br−=0.64 kg/m³, which corresponds to the degree of oxidation=73.3%; elementary bromine was desorbed by atmospheric air and absorbed with an ammonium bromide solution with a concentration of 395.5 kg/m³ on a packed column; the absorbent saturated with elementary bromine was reduced with a 25% ammonia solution; the resulting ammonium bromide concentrate was evaporated on a gas burner until ammonium bromide crystals precipitated; the resulting crystals were dried in a drying cabinet; the mother liquor was used to obtain a solution of ammonium bromide as a product. As a result, 4.84 kg of crystalline ammonium bromide with a content of the main substance in the dry product of 99.15% was obtained. After Stage I of oxidation and bromine extraction (Br−=0.64 kg/m³), brine entered Stage II of oxidation with gaseous (anodic) chlorine to a residual content of Br−=0.07 kg/m³, which corresponds to the degree of oxidation in this stage=89.0%. The absorption of sodium bromide solution and the reduction of elementary bromine with ammonia water was performed similarly to Stage I. The resulting concentrate was mixed with the mother liquor after precipitation of ammonium bromide crystals from Stage I and evaporated on a gas burner to the required density, and this solution was used as a product. The resulting liquid product was 4.46 dm³ with a density of 1,233 kg/m³ and sodium bromide content of 32.7%. The overall degree of bromine recovery from the brine was 97.1%.

Example 2. The composition of the initial brine differs from Example 1:1, 195 kg/m³, with a hydrogen index of 5.3 of the following composition: (Ca2+, Mg2+, Sr2+)=49.55 kg/m³; Feₜₒₜₐₗ=0.003 kg/m³; Mg2+=0.005 kg/m³; (K+, Na+, Li+)=25.98 kg/m³; Cl=166.8 kg/m³; HCO3−=0.024 kg/m³; SO42−=0.55 kg/m³; Br−=3.12 kg/m³. The volume of brine was 2.8 m³. The degree of bromine oxidation in Stage I was 73.4%, which corresponds to a residual concentration of Br=0.83 kg/m³; in Stage II, the degree of oxidation was 89.16%, which corresponds to Br−=0.09 kg/m³. The following was obtained: 5.7 kg of crystalline ammonium bromide with main substance content of 99.02%; 3.83 dm³ of liquid product with a density of 1,230 kg/m³ and sodium bromide content of 32.5%. The overall degree of bromine recovery from the brine was 97.12%.

Example 3. The composition of the initial brine differs from Example 1:1, 364 kg/m³, with a hydrogen index of 5.17 of the following composition: (Ca 2*, Mg 2+, Sr 2*)=162.25 kg/m³; Feₜₒₜₐₗ=0.005 kg/m³; Mg 2*=0.005 kg/m³; (K*, Na*, Li*)=27.7 kg/m³; Cl=166.8 kg/m³; NCO3=0.8 kg/m 3; SO42−=0.003 kg/m³; Br−=8.25 kg/m³. The volume of brine was 2.0 m³. The degree of bromine oxidation in Stage I was 73.0%, which corresponds to a residual concentration of Br−=2.23 kg/m³; in Stage II, the degree of oxidation was 88.34%, which corresponds to Br−=0.26 kg/m³. The following was obtained: 14.0 kg of crystalline ammonium bromide with the content of the main substance of 99.2%; 9.8 dm³ of liquid product with a density of 1,231 kg/m³ and sodium bromide content of 32.6%. The overall degree of bromine recovery from the brine was 96.85%.

### REFERENCES

1. USSR Patent No. 8215, Class 12/J. H. Van der Meulen. 1929.
2. Pozin M. E. Technology Pertaining to Mineral Salts. 4th ed. Leningrad, “Khimiya” Publisher, 1974. Part 1. 233 pp.
3. RF U.S. Pat. No. 21,354,060, published on 27 Aug. 1999.
4. USSR Inventor's Certificate No. 783229, published on 30 Nov. 1980.
5. USSR Inventor's Certificate No. 138232, published on 1 Jan. 1961.

1. Method for producing ammonium bromide from a bromide-containing polycomponent hydromineral feedstock of commercial brines of the chloride calcium-magnesium type, which consists in the fact that the brine stream, purified from dissolved iron, manganese, and insoluble impurities, is subjected to preheating to 30-35° C., neutralization of alkalinity, and acidification to pH values of 2.5 using mineral acids to prevent hydrolysis of free bromine, then the oxidation of bromide ions with gaseous chlorine to elementary bromine is performed in two stages: in Stage I, the oxidation of bromide ions to elementary bromine is performed at 73%-74% of the initial content in a flow chlorinator operating in a countercurrent mode; the air desorption of elementary bromine is performed in a countercurrent mode in a desorber; the absorption of elementary bromine from a bromine-air mixture is performed in a column-type mass transfer apparatus with a multidirectional screw nozzle operating in a countercurrent mode; a cooled ammonium bromide solution with a concentration of 400 g/dm³ is used as an absorbent; then the reduction of absorbed elementary bromine in the form of complex bromide (NH4 [Br2] Br) to bromide ions is performed in the reactor; the resulting ammonium bromide solution is purified from bromine impurities using formic acid, then the purified ammonium bromide solution is evaporated in two stages: in Stage I, evaporation is performed to a concentration of ammonium bromide of 50% in vacuum evaporators with water vapor recompression; in Stage II, evaporation is performed in evaporators equipped with steam jackets and anchor-type mixers, and evaporation is performed until a pulp containing ammonium bromide crystals is obtained, with a ratio of ammonium bromide to water of 3:1, the resulting pulp is cooled to 60-62° C. and subjected to centrifugation to separate crystalline ammonium bromide from the mother liquor, then the separated crystals are dried in a screw dryer, and after Stage I of desorption, a bromide-containing polycomponent hydromineral feedstock is supplied for the oxidation of bromide ions to elementary bromine with gaseous chlorine up to 88% 90% of its residual content in order to extract the residual amount of bromine.

2. The method according to claim 1, characterized in that the subsequent operations of air desorption of bromine, absorption of bromine-air mixture, reduction of absorbed elementary bromine, and purification of the resulting ammonium bromide solution are similar to Stage I of oxidation.

3. The method according to claim 1, characterized in that the purified ammonium bromide solution mixed with the mother liquor from the stage of obtaining crystalline ammonium bromide is evaporated to the required density to produce the ammonium bromide solution as a commercial product.
